(19) United States
(12) Patent Application Publication
(10) Pub. No.: US 2004/0166942 A1
(43) Pub. Date: Aug. 26, 2004

(54) Distributed game accelerator

(76) Inventor: Robert Linley Muir, Artarmon (AU)

Correspondence Address: KATTEN MUCHIN ZAVIS ROSENMAN, 575 MADISON AVENUE, NEW YORK, NY, 10022-2585, US

(21) Appl. No.: 10/787,355

(22) Filed: Feb. 25, 2004

Related U.S. Application Data
(63) Continuation of application No. 09/370,648, filed on Aug. 6, 1999, now abandoned.

(30) Foreign Application Priority Data
Feb. 10, 1997 (AU) PO5041
Aug. 15, 1997 (AU) PO8622

(51) Int. Cl. G06F 17/00; G06F 19/00

(52) U.S. Cl. 463/43

(57) ABSTRACT

A method and apparatus is provided, in which a gaming server 11 is responsible for accounting, game play, and payouts, while the game console 12 is primarily responsible for presenting the user interface. In the general case, communication delays are eliminated by generating game outcomes locally to the console which will be used to determine game outcome to the console prior to the player making their selection. The random numbers used to generate game outcomes are generated in a highly secure device and cannot be used to determine the correct choice of player selection or influence the game outcome. When the player makes a selection the random numbers are already available to the console and the game outcome can be determined and displayed immediately, independent of communication delays.

### CROSS-REFERENCE TO RELATED APPLICATION

This is a continuation of U.S. application Ser. No. 09/370,648, filed Aug. 6, 1999.

### INTRODUCTION

The present invention relates to the field of gaming machines and in particular the invention provides a method and apparatus for speeding up the response time of games played over a network, beyond that achievable using traditional systems.

### BACKGROUND OF THE INVENTION

Traditionally gaming machines have been provided as stand alone devices connected via a network for information gathering, however in the recent past, distributed gaming systems have been proposed to meet the changing needs of the gaming industry.

In a distributed gaming system games are split across the server and console. In its simplest form, when the player presses the ‘play’ button on the console, the console relays that fact to the server. The server may then decide to start a game, and if so instructs the console to initiate a spinning reel display. The spinning reel display will run for a set period and then come to a stop with a certain set of symbols showing, as directed by the server. The players account is adjusted by the server according to the game outcome. The console is instructed of the account details by the server for display.

It is a fundamental requirement for security that the game outcome and accounting are solely determined by the server. The console simply provides a user interface. If the game were to be in any way independently controlled by the console then the potential would exist for tampering. Therefore considerable data must be exchanged between the server and console, however communication delays limit the speed and interactivity of games.

The combinations of a game describe the mathematical structure of the game and define all possible games, including the winning patterns and the payouts associated with each. From the combinations the game statistics are determined, including the theoretical return to the player.

A limitation and crucial factor in game play in a traditional distributed gaming system is the response time of games to user input. This time is determined by network and server response times. If either of these is not adequate then the user will notice delays in playing the game.

A game used as an example is the red/black double up. It is a common feature game requiring a fast response time. A card is shown face down on the display so that the colour cannot be seen. The game selects a colour for the card, and the player tries to guess what colour the card is, i.e. red or black. The player has a 50% chance of guessing the correct colour and wins double or nothing.

Consider the red/black double up game. When the player makes a selection they expect to instantly be shown the outcome. Any delay must be kept small for the game to be playable. In existing systems it was a requirement that the network did not impose significant delays, or alternatively that games played on the system were designed to make such delays less noticeable.

In this context, the term “outcome” can have two meanings:-

a) the indicia or images displayed at the end of a game

b) the result of the gamble (i.e., win/loss and value of prize).

The first of these outcomes we will call the ‘game outcome’ while the second we will call the ‘gamble outcome’. In most game types, game outcome and the gamble outcome are directly linked. However, in some instances, such as the red/black gamble referred to above, they are not because the game outcome is a particular colour of card while the gamble outcome will depend upon which colour was selected by the player. The gamble outcome is also determined by the size of bet selected by the player. The term “outcome” describes the combination of both the game outcome and the gamble outcome.

### SUMMARY OF THE INVENTION

According to a first aspect, the present invention provides a method of operating a gaming system including at least one gaming console, the console including secure storage means and a user interface allowing a user to initiate a game and observe a result, the method including the steps of:

storing game or gamble outcome information in the secure storage means for use by the console to produce a game or gamble outcome; and

upon receipt of a user input initiating a game, producing a game play sequence including a game and/or gamble outcome indication determined by the game or gamble outcome information stored in the secure storage means alone or in combination with a user input.

According to a second aspect, the present invention provides a gaming system including at least one gaming console, the console including secure storage means and a user interface allowing a user to initiate a game and observe a result, the system including:

secure storage means for storing game or gamble outcome information used by the console to produce a game or gamble outcome; and

game control means in the console arranged to receive a user input initiating a game and to produce a game play sequence including a game and/or gamble outcome indication determined by the game or gamble outcome information stored in the secure storage means alone or in combination with a user input.

According to a third aspect, the present invention provides a secure storage means for use in a gaming console which includes a user interface allowing a user to initiate a game and observe a result, the secure storage means being arranged to store game or gamble outcome information used to produce a game or gamble outcome.

According to a fourth aspect, the present invention provides a secure removable control device for use in a gaming console which includes a user interface allowing a user to initiate a game and observe a result, the control device being arranged to generate game or gamble outcome information used by the console to produce a game or gamble outcome.

The information stored in the secure storage means or generated by the control device may be a sequential list of outcome information relating to a sequence of future games to be played on the console, a set of random numbers sufficient to generate one or more entire game outcomes, or a random number seed from which outcome information relating to a sequence of future games to be played on the console is generated by operation of a pseudo-random number algorithm. Preferably, the game outcome information generated by a pseudo-random number algorithm, will be in the form of a set of random numbers sufficient to generate an entire game outcome.

In one possible embodiment the outcome information is a random number indicating a gamble outcome value and the secure processing means in the console then chooses a game outcome which will achieve that gamble outcome value, however generally the information will indicate an outcome and the gamble outcome value will be determined from the game outcome.

Preferably the secure storage means or control device is removably connectable to or readable and writable by the console.

In one embodiment, the information relating to future game outcomes stored in the secure storage means is stored before the secure storage means is connected to the console. Preferably the secure storage means is a programmable card which is preprogrammed with outcome information before or after acquisition by a user and is inserted into the console by the user to produce one or more game outcomes on the respective console.

In one embodiment the production of the game outcome indication is performed in a secure processing means connected to the secure storage means by way of a secure communications path.

Preferably also the secure processing means or control device includes a smartcard or smartcard chip which is either removably inserted into or permanently fixed in the console.

The console and therefore the secure storage means or control device, may or may not be connected to the server when the game is played, but in either event, when the secure storage means or control device is next connected to the server, it will generate and send a signal to the server indicating that the stored precalculated result has been used.

According to a further aspect, the present invention provides a virtual casino including a plurality of virtual gaming machines (or gaming consoles, each gaming machine or console having dedicated accounting, and combinations, being uniquely identified and capable of being returned to at any time by the player provided it is not in use by another player.

In a virtual casino, as in a traditional casino, if another player is using a particular virtual machine then, the player must wait or play another machine. Preferably embodiments of the invention will allow a player to view a virtual machine while it is being played by another player.

The return remains with the machine for the life of that machine. Unused return is mathematically equivalent to money and can thus be transferred between games, either as money or combinations changes. To be fair to players and prevent the casino from cheating, when player accounts are shut down, virtual game machines are ended, the gaming site is to be closed, or jackpots are cancelled, etc, the extra accumulated return owed to players is transferred from the various accounts and redistributed among the players, as jackpots, credits, combinations, etc.

Preferably, the game outcome determining data is stored in the secure storage means and the game outcome is calculated from the data in a secure processing means connected to the secure storage means by way of a secure communications path.

The data precalculated by the server and sent to the secure storage means in the console, may be in the form of a set of random numbers sufficient to generate an entire game outcome (i.e., 5 random numbers in the case of a slot machine with a 5 reel display) or alternatively, the precalculated data may be a random seed from which the secure processing means may calculate the required number of random numbers using a pseudo-random number generating program. In another alternative arrangement, the server may calculate an actual game outcome (eg, reel stopping positions or indicia) and transmit codes indicating these positions although this arrangement is inconvenient in a machine capable of playing any one of a number of player selectable games as the server would have to precalculate outcomes for each possible game.

In an alternate embodiment, predetermined outcomes can be implemented using a smartcard as the secure storage and processing means, with predetermined bets and outcomes stored simply as a list of values. Initially all values on the card (except the first which is the initial value of the card) are hidden and playing games discloses the values one by one. The player may redeem the card at any time for the amount of the last disclosed value. The console displays an appropriate game which generates the new value. The player buys a smartcard (or downloads values from a casino) with a fixed number of values. An advantage of this system is that the casino knows the wins and losses of every card released and can adjust the pattern of wins and losses as desired.

In another embodiment a smartcard is provided with a list of predetermined outcomes, with the player making bets on each outcome. The outcomes are initially hidden and are disclosed one at a time as games are played. For each outcome disclosed the player first makes a bet, which is written to the smartcard (in non-volatile memory). The total value owed to the player is simply the sum of wins and losses for each bet and outcome. The player redeems the card for value stored by returning the card. This may be implemented with a very simple and hence cheap smartcard, requiring only secure memory storage with controlled access. In another implementation the value is redeemed via secure communications with a game server.

The smartcard may be programmed with multiple functions, only one of which is a gaming accelerator. In other modes the smartcard may for example be used as an ID card, a credit card, a bankcard (eg. ATM), etc. The protocol to access the smartcard may be an extension to another, perhaps primary, mode of the smartcard.

In yet another possible alternative arrangement, the server calculates a number indicating a gamble outcome value (per unit bet) and the secure processing means in the console then chooses an outcome which will achieve that win value. This arrangement will work better with some games than others, although, the concept could be altered to suit each game played.

In preferred embodiments of the invention, signals generated by the server and console to send game outcomes or to indicate game play, are encrypted prior to being sent.

Preferably, also encrypted signals are each provided with a piece of unique information prior to encryption such that different signals containing the same game information are not the same after encryption.

Preferably also, the server includes an auditing function to check the game and/or gamble outcome data returned from the secure device in the console.

In one embodiment of the invention, the secure storage and processing means is a smart card which may be permanently fixed in the console or may be removable and may also be used to carry player identification and credit information. Preferably, when a smart card is used as the secure memory and processing means, the encryption and decryption in the console of signals to and from the server and the game outcome calculation will be performed by the smart card.

In one preferred form of the invention, an hierarchical network of gaming servers are provided with the console connected to low order, low security network servers which perform low security and routine control and communication, while passing high security signals to higher level gaming servers having higher security.

### BRIEF DESCRIPTION OF THE DRAWINGS

Embodiments of the invention will now be described, by way of example, with reference to the accompanying drawings in which:-

FIG. 1 is a block diagram of a distributed gaming system;

FIG. 2 is a more detailed block diagram of the server and console components of a distributed gaming system of FIG. 1;

FIG. 3 is a flow chart showing an initialisation sequence for a system according to the present invention;

FIG. 4 is a flow chart showing a sequence of steps in the playing of a game on a system according to the present invention;

FIG. 5 is a diagram showing a Blackjack hand as it is initially dealt;

FIG. 6 is a diagram of a message format for a message from the smartcard and server;

FIG. 7 is a flow chart showing a random number buffering arrangement;

FIG. 8 is a block diagram of a system employing a random number server;

FIG. 9 is a block diagram of a distributed gaming system including a security server; and

FIG. 10 is a block diagram of a distributed gaming system including a network of gaming servers.

### DETAILED DESCRIPTION OF THE EMBODIMENT

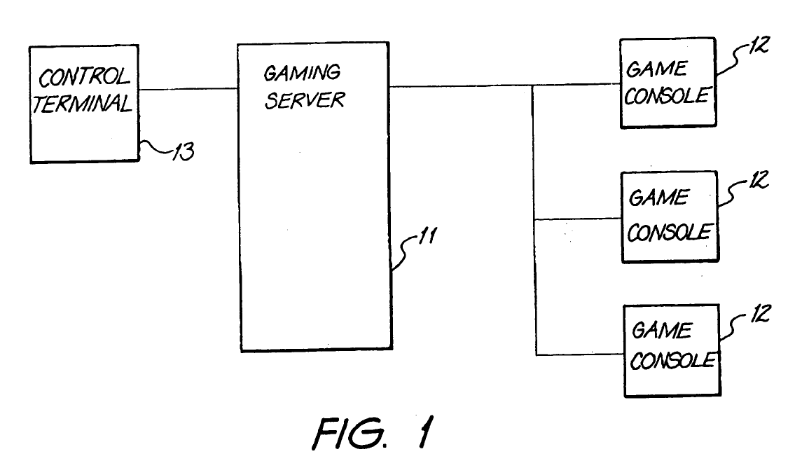

Embodiments of the invention will now be described in which the gaming server 11 (refer to FIG. 1) is responsible for accounting, game play, and payouts, while the game console 12 is primarily responsible for presenting the user interface. The console 12 may also keep accounts for the player and run the game combinations, but only as an aid to the rapid update of the display. The real accounts and the combinations are held on the server 11 and the player will be paid as the server determines. Although the console 12 can in theory be tampered with to affect the combinations and accounting any changes will be local to the console 12, and cannot affect the accounting on the server 11, and hence payout. For the sake of completeness, a control terminal 13 is illustrated in FIG. 1. This control terminal is used by the system operator to manage the gaming server 11.

For a system able to transparently cope with significant delays occurring throughout the system several advantages can be derived as follows, depending on the embodiment used.

A slower response time from the server 11 is allowable. A cheaper, lower performance server system may be used. In a multiple server installation extra servers may even be eliminated. In addition server software will be easier to develop due to the lower performance constraints.

Network delays may be allowed to increase. Cheaper, lower performance networking may be allowed. Internet gaming performance can be improved.

Delays associated with distance are ultimately limited by the speed of light, and cannot be overcome. International delays are therefore significant and cannot be reduced beyond a certain point. However embodiments of the invention can reduce or eliminate the effect of such delays.

Network and server delays may be eliminated or significantly reduced at the console 12 in some circumstances by not waiting for a response from the server 11 before giving the player feedback. Some games do not require knowledge of the gamble or game outcome to continue, although the game cannot be completed until it is known.

In the general case, the delay can be effectively eliminated by sending the random numbers which will be used to determine game or gamble outcomes to the console 12 prior to the player making their selection. These numbers are stored in a highly secure device 23 and cannot be used by the player (or a cheat) to determine the correct choice of player selection. When the player makes a selection the random numbers are already available at the console 12 and the game outcome can be determined and displayed immediately.

Games may be played locally on the console 12 in a similar way to that found in a traditional gaming machine. The key difference being that game outcomes are not determined by the console 12, and that they are audited by the server 11. The players choice is passed to the secure device 23 and it informs the console 12 of the subsequent game outcome. An unforgeable message is generated to advise the game server 11 of the game outcome.

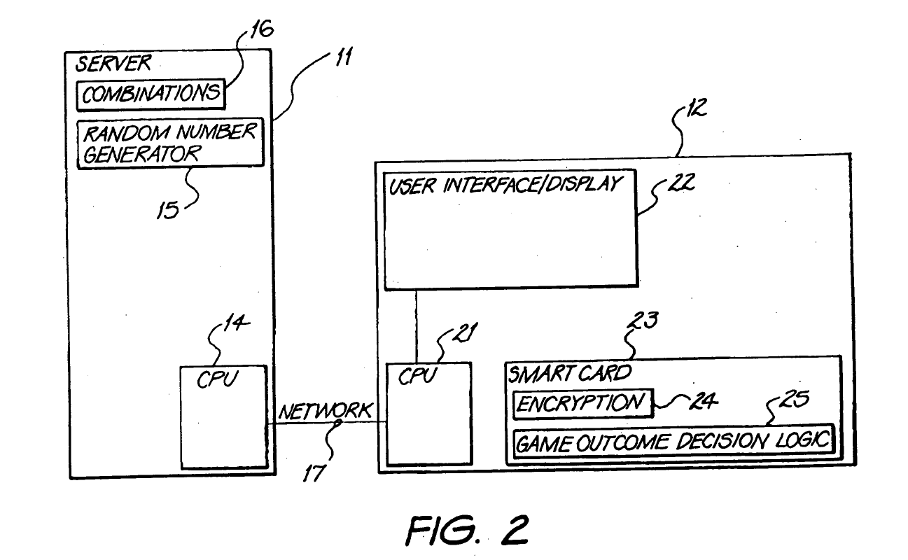

In the embodiment illustrated in the block diagram of FIG. 2, it will be seen that the server 11 includes a CPU 14 and is used to store combinations 16 and to perform random number generation 15. The server 11 is connected to one or more consoles 12 via a network 17 and each console 12 includes a CPU 21, a user interface 22 and a secure storage and processing device 23 arranged to provide encryption/decryption functions 24 and game outcome logic 25.

The secure storage and processing means in the console 12 may be achieved by using a relatively standard processor on a separate board within a security cage using techniques presently common in the gaming industry or these functions may be realised in a secure software routine that continuously checks itself for tampering or makes use of a hardware device to constantly monitor itself for validity. The software embodiment, could for example make use of a hardware decryption circuit that decrypts the program and data on the fly during executions and constantly sends encrypted messages to the server 11 to indicate the valid status of the decryption circuit.

In the preferred implementation the secure random number storage and processing device 23 is an ISO 7816 smartcard (or smartcard chip) with embedded microprocessor 21, program ROM and E²PROM. The smartcard 23 is provided with an encryption function 24 either via software or a hardware accelerator. The smartcard 23 has a 5 pin interface with serial communications for connection to a reader in the console 12.

The smartcard 23 may be inserted into the console 12 by the player or embedded within it by the manufacturer. A smartcard or smartcard chip may also be enclosed within a module which is inserted into the console 12, for example, within a PCMCIA card which is then plugged into a personal computer.

In the following description the smartcard 23 and server 11 are sometimes referred to as communicating directly with each other, without the aid of the console 12. This is for simplicity of description, but it must be realised that the console 12 must act as the intermediary. The console 12 does not interpret or modify any such communications.

In the following embodiments, the game outcome data is preferably transmitted from the server 11 and stored in the console 12 as a random number seed from which any number of random numbers required for the game may be generated.

The game server 11 is responsible for accounting, game play, and payouts, while the game console 12 is primarily responsible for presenting the user interface. The console 12 may also keep accounts for the player and run the game combinations, but only as an aid to the rapid update of the user interface. The real account and combinations is held on the server 11 and the player will be paid as the server 11 determines. The console in effect presents a simulation of the game that is run on the server. Although the console 12 can in theory be tampered with to affect its combinations and accounting any changes will be local to the console 12, and cannot affect the accounting on the server 11, and hence payout.

Predetermined Outcomes

In the preferred implementation random numbers within the secure storage and processing device 23 are used to generate game outcomes as required by the console 12. In an alternate method, called predetermined outcomes, the server 11 determines game outcomes prior to games being played and securely transmits them to the secure storage and processing device 23. When a game is played the console 12 requests one of these game outcomes from the secure storage and processing device 23 and produces a display appropriate to the outcome. Game outcome messages are preferably secured using encryption techniques to prevent cheats decoding messages to determine the outcomes before they are played. Alternately physical security of the communications medium may be used.

For example, consider the red/black double-up game. In the preferred implementation the outcome is dependent on the match between the player selection and random number within the smartcard 23. Using predetermined outcomes the secure storage and processing device 23 contains a predetermined win or lose outcome and the player selection makes no difference to the game outcome. The console 12 outputs an appropriate win or lose display according to the predetermined outcome and player selection. If the player wins the console 12 shows the hidden card the same colour as the players choice, while if the player loses the console shows the opposite colour. The secure storage and processing device 23 generates an unforgeable message to the server 11 informing it of the outcome selected and the amount bet.

Consider also slot games. Again outcome is predetermined, but with the win outcome also containing a win multiplier which is the multiple of the bet that the player wins. The console 12 displays the outcome appropriate to the win or loss, which may be selected randomly from a range of possible win or loss displays.

The console 12 requests and buffers game outcomes from the server 11 appropriate to the games to be played. Before all of the outcomes have been used the console 12 requests replacement outcomes from the server 11.

In an alternate application, predetermined outcomes can be implemented using a smartcard 23 as the secure storage and processing device 23, with predetermined bets and outcomes stored simply as a list of values. Initially all values on the card (except the first which is the initial value of the card) are hidden and playing games discloses the values one by one. The player may redeem the card at any time for the amount of the last disclosed value. The console 12 displays an appropriate game which generates the new value. The player buys a smartcard (or downloads values from a remote casino) with a fixed number of values. An advantage of this system is that the casino knows the wins and losses of every card released and can adjust the pattern of wins and losses as desired.

In another application a smartcard 23 is provided with a list of predetermined outcomes, with the player making bets on each outcome. The outcomes are initially hidden and are disclosed one at a time as games are played. For each outcome disclosed the player first makes a bet, which is written to the smartcard 23 (in non-volatile memory). The total value owed to the player is simply the sum of wins and losses for each bet and outcome. The player redeems the card for value stored by returning the card. This may be implemented with a very simple and hence cheap smartcard, requiring only secure memory storage with controlled access. In another implementation the value is redeemed via secure communications with a game server 11.

In another implementation the secure storage means and secure processing means are two separate devices, preferably smartcards. Predetermined outcomes and/or bets are loaded from the server to the secure storage means. When the secure processing means and secure storage means are in communication games may be played as the secure processing means uses the predetermined outcomes stored on the secure storage means. The secure storage means may also store the players credit account which is gambled on and adjusted by the secure processing means during game play, or alternatively a separate secure storage means, preferably yet a further smartcard or smartcard chip is provided to store credit account information. One application of this implementation is where the secure storage means is a multi-application smartcard where the smartcard acts as a secure filing system. Each application is a separate smartcard with secure access to the data file area. The gaming system is simply one of the many applications, with the secure processing means being the other smartcard. A secure access means provides the off-line communication between server and secure storage means to download or update the stored predetermined outcomes and/or credit information.

Applications

In Internet applications the smartcard 23 may be used in conjunction with a PC via a standard smartcard interface or an adaptor such as a PCMCIA card, or directly connected to a network computing device with built in smartcard interface (eg. Sony WebTV, Oracle N.C.).

The smartcard 23 (or socket) may be integrated with a modem and game program memory within a module for a game console (eg Sony Playstation or Nintendo Ultra64). The game console 12 is then capable of highly interactive gambling.

The smartcard 23 may have multiple functions, only one of which is a gaming accelerator. In other modes the smartcard 23 may for example be used as an ID card, a credit card, a bankcard (eg. ATM), etc. The protocol to access the smartcard 23 may be an extension to another, perhaps primary, mode of the smartcard.

A secure storage and processing device may be used to enhance security in an otherwise traditional distributed gaming system (such as Internet, hotel in-room gaming or on a ship) by securing the game outcome determining function of the server. Depending on the implementation used and as described elsewhere, random numbers (or game outcomes) are either generated by the secure storage and processing device or received from a random number server at a more secure location. Random numbers (or game outcomes) generated at another location are securely (eg. by encryption) communicated to the game server and hence secure storage and processing device by a communication link or a storage medium such as a CD-ROM or hard disk. The game server sends player requests to the secure storage and processing device and receives game outcomes, which it then communicates to the player consoles.

Software Method of Disguising Delays

Network and server delays may be effectively eliminated at the console 12 in some situations by not waiting for a response from the server 11 before giving the player feedback. The game console 12 must be able to process user input and take actions without waiting for commands from the server 11. For example when the user presses play, a message is sent to the server 11 as usual, but the reels also start spinning immediately.

To maintain security it is essential that the outcome of games be determined only by the server 11, but this does not limit the starting of reel spins (or other events), only stopping of the reels. The typical reel spin time of three seconds can easily encompass a network/server delay of two seconds before the game outcome is received and the reels slow down and stop.

If the response was not received within a set period, say 30 seconds, the console 12 would abort the game without the usual stop and clearly indicate to the player that the current game display is invalid, but that a game may have taken place. A message is then sent from the console 12 to the server 11 indicating a time-out error. Two events may have occurred

The server 11 did not receive a start of game message, therefore the game did not take place. A new game may be played.

The server 11 received the start of game message and played the game, but the console 12 did not receive the servers game outcome message. The game has taken place and the players account updated, but the player does not know what happened. The game is redisplayed on the console 12 as soon as possible.

Preferred Implementation

In the preferred implementation the secure storage and processing device 23 is an ISO 7816 smartcard (or smartcard chip) with embedded microprocessor, program ROM and E²PROM. The smartcard 23 is capable of encryption either via software or a hardware accelerator. A smartcard has a 5 pin interface with serial communications.

The implementation could also be a microcontroller or a secure multi-component module. The key requirement being that it is not possible to determine the internal operation of the module, and hence the random numbers or security keys.

Initialisation

Communication must be established between the server 11 and smartcard 23 prior to any games taking place. Each smartcard 23 is provided with a unique preprogrammed ID number and secret encryption key. Preferably the ID number and secret encryption key are encoded into the smartcard after manufacture but before distribution to the casino or users. The server is informed of the card ID and matching encryption key, which will be the same as the smartcards key or different depending on whether symmetric or asymmetric encryption is used.

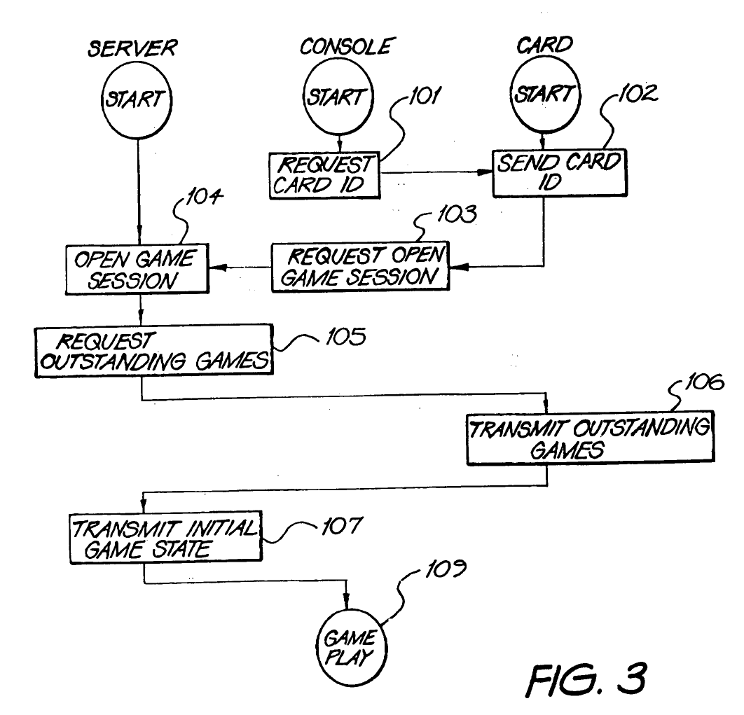

Referring to FIG. 3, during initialisation the console 12 reads 101, 102 the ID from the smartcard 23 and informs 103, 104 the server 11. The server 11 uses the ID to look up the encryption key used to communicate with the smartcard 23 and allows the console 12 access to the account information once the server 11 has authenticated the smartcard 23. The console 12 may access the players account for information including credit available, game preferences and game initialisation, following authentication of the smartcard 23 by encrypted communications.

The ID is not itself required during communication with the smartcard 23, as due to the encryption, if the wrong ID is supplied communications cannot take place. An exception to this is in an alternate implementation where the same keys are used for all cards, when the ID must be encoded into all messages to prevent the same random numbers being played on more than one card. Although the ID may be the smartcards public encryption key, preferably, in the interests of security this is not disclosed.

Console to server communication of the smartcard ID is one of the few types of message that is not encrypted, as it is performed by the console 12 rather than the smartcard 23. In an alternate implementation these messages may also be encrypted using a public key that the server 11 publishes. Encrypted messages may thus be sent to the server 11 that only the server is able to decode.

Referring again to FIG. 3, in the preferred implementation the server 11 first checks 105 the smartcard 23 for unacknowledged games, and the smartcard responds 106 with details of the outstanding games it is holding. The server then transmits 107 an initial game state to the console 12 and enables initiation of game play 109. Where the previous game was interrupted (eg. due to a communications failure or player choice) this restores the last state of the game. Preferably the initial state includes the current value of the players account. It may also be requested during game play to ensure that the game simulation that the player sees correctly reflects the true account held by the server.

In some types of game the combination being played depends on previous games, changing during the course of game play. For example, after 100 games with a return of 85% the player is given 10 games at 90% return. This change in combinations affects the long-term return to the player and therefore the method of initialisation, which can be one of:

The server 11 always initialises the game to the same state, maximising the return to the server.

The last game state is recorded in the player's account and the same state is restored during initialisation.

The last game state of the player is randomly assigned to the next player to play that game. This is analogous to the situation in a casino, when one player finishes with a gaming machine and the next player starts. The average return to the casino does not increase.

Virtual Casino

To further simulate an actual casino environment a Virtual Casino may be created. The Virtual Casino contains a (preferably large) number of virtual gaming machines which act like gaming machines in a traditional casino. Each has it's own accounting, combinations, etc, is uniquely identified and can be returned to at any time by the player, but may only be played by one player at a time. If a player is using a particular virtual machine then as in a traditional casino other players must wait or play another machine. Therefore the return remains with the machine for the life of that machine. To further simulate a real casino players may be able to observe another player play a virtual gaming machine and to start playing that virtual gaming machine when the current player ceases. A queue mechanism may be used where multiple players want to play the same virtual gaming machine.

Unused return is mathematically equivalent to money and can thus be transferred between games, either as money or combinations changes. To be fair to players and prevent the casino from cheating, when player accounts are shut down, virtual game machines are ended, the gaming site is to be closed, or jackpots are cancelled, etc, the extra accumulated return owed to players is transferred from the various accounts and redistributed among the players, as jackpots, credits, combinations, etc.

Game Play

In the preferred implementation the smart card generates the random numbers used to calculate game outcomes from an initial seed set prior to use of smart card and optionally periodically updated from the server.

In an alternate implementation random number seeds are generated by the server 11 and sent to the smart card prior to each game. In this implementation, the random number seed, combined with an auto-incrementing index (the seed index) is encrypted such that only the smart card can decode it. The smartcard 23 uses the seed to generate as many random numbers as required for the next game. Each time a new seed is generated a unique new index is used. The index is unique to a game and is used to identify that game to the server 11 for the game outcome, and again for the server to acknowledge receipt of the game outcome to the smartcard 23.

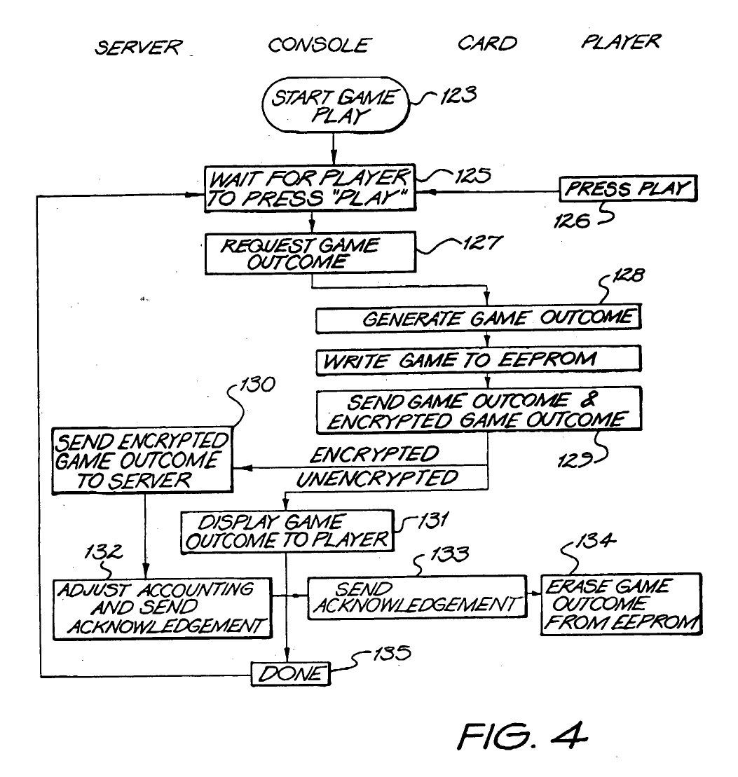

FIG. 4 illustrates the game play sequence, following initialisation in FIG. 3 and the selection of a game to play. Once the player has selected the game type the console 12 sends the selection to the smartcard 23, together with the game description and amount bet. The smartcard 23 then writes the game type, player choice(s), amount bet, game outcome and card index to its internal E²PROM memory. The smartcard 23 must inform the server 11 of the amount bet, otherwise tampering could occur with the server being told that losses had small bets, while wins had large bets.

The console 12 then requests a game outcome, which the smartcard 23 generates, stores in E²PROM and then sends to the console, which can immediately display the result to the player. The smartcard 23 also generates an unforgeable encrypted game outcome message for the server containing the game type, gamble, player choice(s), amount bet game outcome, and card index which it sends to the console 12, and hence to the server 11. The server 11 decrypts the message and is thus informed of the game played and is able to adjust the account correctly. The server 11 then sends an acknowledgment to the smartcard 23, which responds by erasing that outcome from its E²PROM. Games are recorded in the smartcards E²PROM until acknowledged by the server 11. Unacknowledged games will quickly fill the available memory and stop the smartcard from accepting new games.

Security is dependent on it being impossible to determine what encrypted message to send back to the server 11 if the wrong choice of gamble is made. Only the smartcard has this information.

The game type uniquely identifies each type of game to the server 11. Many games may share the same combinations, but each has a different game type. Note that the combination type may be sent instead of the game type, but auditing (to check popularity of games, for example) is better served by sending the game type.

In another variation, after initialisation (eg. power up), the card may refuse all games until any outstanding game outcomes in E²PROM have been acknowledged by the server 11.

So far only the first game has been accelerated. To eliminate delays in subsequent games two factors must be considered

A new game must be able to take place before the server 11 acknowledges receipt of the first game outcome.

New random numbers must be available immediately.

When the server 11 has not yet acknowledged the previous game before the player starts the next, a number of game outcomes may be stored in E²PROM. The next game may be played immediately assuming more random numbers and space is available. Games can continue to be played until the limit of E²PROM memory is reached, random numbers are no longer available, the total value of player losses in outstanding games reaches the preset loss limit, etc.

The server 11 may at times require that all game outcomes outstanding in the smartcard must be acknowledged, in particular before the player collects money from their account. The server 11 may query the smartcard for outstanding games, or in an alternate implementation simply maintain a list of the random numbers seeds that have not yet been used.

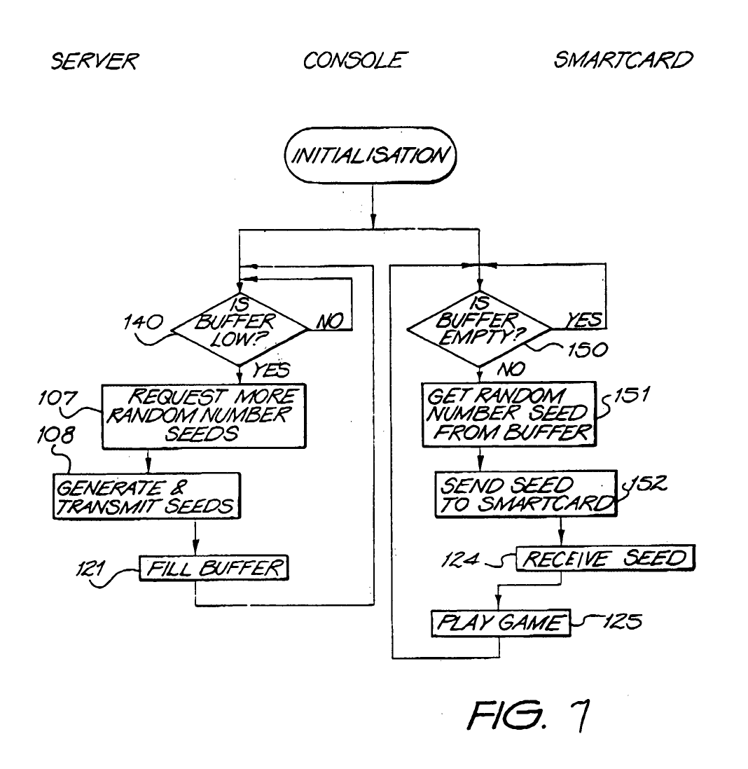

In the alternative implementation, where the server generates a random number seed for each game, before a game starts a random number seed is generated 108 (refer to FIG. 4 and FIG. 7) by the server 11, combined with the seed index, encrypted, and sent to the console 12 where it is stored 121 at or prior to start of game play 123. Referring to FIG. 7, maintenance of the seed buffer is performed by a background task that regularly tests 140 the state of the seed buffer in the console 12 and if it contains less than a predetermined number of seeds, a request 107 is generated to the server 11 for more seeds. As the seeds are encrypted and contain an encrypted sequence number, the buffer does not need to be maintained in a secure part of the console 12.

When a game requires a seed to generate a set of random numbers, the console 12 tests the buffer 150 to ensure it is not empty and then retrieves 151 a seed and sends 124 the seed to the smart card where it is received 157 and any required additional random numbers generated. In the event that a game requires only one random number, the seed may be used directly as the random number, however, where more numbers are required, the smartcard uses a pseudo-random number algorithm known to the server 11, such that the server can predict the numbers generated by the seed.

Only the smartcard is able to receive and decrypt 124 the seed. Referring to FIG. 4 the smartcard uses the seed to generate 129 as many random numbers as required for the next game outcome. Each time a new seed is generated 108 a unique new index is used. The index is unique to a game and is used to identify that game to the server 11 when reporting 130 the game outcome, and again for the server to acknowledge receipt 132, 133 of the game outcome to the smartcard.

Once the type of game has been selected 123 by the player the console 12 waits 125 for the player to press play 126 and then sends this information to the smartcard with a request 127 for a game outcome, together with the game type and amount bet. The smartcard then writes 128 the received seed index or card index, game type, gamble type, player choice, amount bet and outcome (note: the outcome is not strictly required as the server is also able determine it) to its internal E²PROM memory.

The smartcard informs the server 11 of the amount bet otherwise tampering could occur with the server being told that loses had small bets, while wins had large bets.

The game outcome 131 is then sent to the console 12, which can immediately display the result to the player. The smartcard also generates 129 an unforgeable encrypted game outcome message for the server 11 containing the seed index, game type, gamble type, player choice, amount bet and game outcome, which it sends to the console 12, and hence 130 to the server. The server 11 decrypts the message and is thus informed of the game played and is able to adjust 132 the account correctly. The server 11 then sends 133 an acknowledgment to the smartcard which responds by erasing 134 the outcome from its E²PROM. When the game is complete 135 the console 12 waits 125 for another player input 126 to commence another game.

Security is dependent on it being impossible to determine what encrypted message to send back to the server 11 if the wrong choice of gamble is made. Only the smartcard knows this and this information is not accessible

When each new random number seed is received the embedded index is checked against that of the most recent game outcome stored in E²PROM. There are three possible outcomes;

The received index is newer (i.e. larger) than that of the last stored game, indicating that it is a new seed, for a new game.

The received index is the same as the stored index, indicating that the game has already taken place, and the console 12 is so informed. No new gamble choice will be accepted. This may occur if the system aborted the game without completing the transaction (i.e. power down) to the console 12, or server 11. It also acts to prevent cheating where the encrypted random numbers are resent and the gamble is tried again with a different choice.

The received index is older (i.e. less) than that of the last stored game. This is either the result of an error in the system or an attempt at cheating. This condition is signalled back to the console 12 and the set of random numbers discarded.

In a variation on the implementation described above, the index must be the next in the sequence for the smartcard to accept the communication. For example, if the last index was 1000, the next must be 1001.

In another variation, after initialisation, (i.e., power up) the card may refuse all games until any outstanding game outcomes in E²PROM have been acknowledged by the server 11.

Where taxes are required to be paid to government these may be calculated from the player accounts.

High Loss Gambles

If the value of a gamble is large it may easily exceed the value of the smartcard. If the smartcard is destroyed then any losses outstanding on the smartcard and of which the server 11 is not aware are lost with the smartcard and the player will not have their account on the server debited with the loss. In some cases it would therefore be in the players best interest to destroy the smartcard and avoid large losses.

A loss limit is programmed into the smartcard, to prevent a single gamble or a series of gambles above the set limit. The loss limit is set by the smartcard issuer to be that value at which it is not worth tampering with the smartcard in this way. In applications where the smartcard is physically secure and there is no question of such tampering, as in a traditional casino environment, a loss limit is not required.

When a series of gambles has been made and are still outstanding (unacknowledged) on the smartcard, the order of notifying the server 11 of game outcomes may be modified to give priority to losses over wins.

One or more of the following methods may be used to deal with high loss games

The player is charged for a new smartcard. For example a player paying $50 for a smartcard will not profit by destroying a smartcard with only $50 losses on it. The loss limit in this case may be $50.

The loss limit is set to such a point that even though it is possible to make money by destroying the smartcard it is not economically worthwhile.

The issuer may detect players who regularly destroy cards and refuse further business with them. Analysis software on the server 11 or off-line aids in detecting suspicious activity.

The player makes a guarantee to the server 11 for a play limit. If the smartcard is destroyed the player forfeits the amount guaranteed. For example the player guarantees $500, and the server 11 instructs the smartcard of a new loss limit of $500. This is analogous to transferring money into the smartcard and if the smartcard is destroyed the player loses $500.

The player may only be able to withdraw money from their account on the server 11 by using the smartcard. If the account is in net credit then the player would have to keep the smartcard safe.

The player must present the smartcard in person to collect winnings, so that the smartcard can be physically examined. This would typically be used if tampering were suspected or the value of the win was large.

The system may revert to the traditional distributed gaming mode for high value gambles, where games are played directly from the server 11 and the smartcard is not used. The gamble is set up on the server 11, the outcome solely determined by the server after the player selection and then transmitted to the console 12.

For high value gambles the console 12 requests a gamble amount from the server 11. The player is then committed to gambling this value or cancelling it via the correct (secure) method. The server 11 responds with an encrypted gamble confirmation message to the smartcard which allows the game to proceed. If tampering takes place and the server 11 never receives a response from the smartcard, the player forfeits the gamble amount initially set up on the server. This method has the delays associated with the traditional method and that this invention is designed to eliminate.

The smartcard may be a multipurpose card, and destroying it may not be worth the trouble caused, due to the nature of the other functions. It may, for example, also be a bank or credit card.

An attempt may be made to tamper with the system by deleting a losing game outcome message before it reaches the server 11, or system errors may cause the loss of messages. Therefore the previous game is stored in E²PROM until the server 11 acknowledges receipt (with an unforgeable message) of the encrypted game outcome message for that game, upon which it may be deleted. The encrypted acknowledge message will at least include an acknowledge code and the card index that identifies that game. One or more of the following methods may be used to detect and prevent tampering where losing messages are deleted.

The server 11 monitors responses from the console 12 and quickly detects lost messages. This is possible using the card index and/or in an alternate implementation the random number seed index. If the cause of lost messages is determined to be the player he is deterred from tampering.

When a message is lost the server 11 cannot acknowledge that game. It will remain in the cards E²PROM and contribute to the loss limit and memory space taken up. Eventually the smartcard will become unusable.

Game outcomes are stored in the smartcards E²PROM until acknowledged by the server 11. In one implementation, any subsequent communications between the smartcard and server allows the server 11 to uncover these stored outcomes. Therefore to lose messages the smartcard may never again communicate with the server 11. In this implementation all game outcome messages to the server 11 may additionally contain the number of game outcomes stored in the smartcard. The server 11 may then request these game outcomes from the smartcard.

Game and Function Description to Smart Card

The console 12 informs the smartcard, and hence the server 11, of the game type to be played. Theoretically this is sufficient for the smartcard to know the combinations for that game and the gamble that is about to take place. However a smartcard preprogrammed with this information will not be able to deal with new games, and the large number of possible games may overrun its memory capacity. Therefore in practice it is preferable for the console 12 to also describe the gamble to the smartcard and hence the server 11.

The game is described to the smartcard using a minimal number of generic descriptions or commands. For some games the generic commands may not be adequate to describe the game and game specific commands may need to be added. As the smartcard contains a microprocessor virtually any type of game command may be added. In response to a command the smartcard generates a response, stores the appropriate information in the E²PROM (for later transmission to the server 11) and then sends a response to the console 12. Generally a game is described by:

The console 12 sends a message to the smart card describing some state of the game to the server 11. The card does not interpret the message, but encodes it for transmission to the server 11. By sending the message to the smartcard the console 12 proves to the server 11 that the message (eg. a player selection) was made at a particular point in the game. Messages include start of game, end of game, player selections, game type, amount bet etc.

The smartcard generates an array of M random numbers, each in the range 1 to N. The numbers may be independently selected (i.e. duplicates may exist) or of unique values. The console 12 subsequently requests numbers from the array, with the smartcard recording the requests and values for transmission to the server 11. Note that a request for a single random number in the range 1 to N is a simple case of an array in which M=1.

When an array is required exceeding the maximum memory capacity of the smartcard the array is split into multiple sub-arrays that are generated independently. Using a selection algorithm that is common to both console 12 and server 11 the arrays are merged (in the console 12 and server 11) and if necessary duplicate values are reselected from the smartcard.

Many games have a fixed sequence of events, however the sequence of events in some games depends on the actions of the player. The server 11 must be able to determine the end of a gamble to update the players account. Preferably the console 12 informs the smartcard, and hence the server of the start and end of games, although this may not be necessary for some types of game in which these are implicit. For example, a winning slot game may be followed by a sequence of up to 5 double-ups. The server 11 is able to determine that the game ends if the player loses on the slot game or any of the double-ups, but must be informed if the player chooses not to play the double-ups.

Card games (eg blackjack) usually deal cards from a single deck of 52, which is reshuffled for each game. Traditional casino games usually deal from a deck of 6 packs of cards, to hinder card counting. Games using 6 packs of cards can be handled in two ways. Preferably cards (random numbers) are selected from the smartcard independently and sequentially. If a card is selected that has already been selected 6 or more times then it is reselected until a valid card is selected. Alternately a special game description command can be added that is able to generate an array representing 6 shuffled packs of cards.

Another example of a special game description command is the use of multiple arrays. The preferred implementation is able to generate and select values from only one array. If a game were implemented that required generation and selection of multiple arrays, extra commands would need to be added. Preferably when such commands are added compatibility with old games is maintained.

Double-Up Game Description

In red/black double-up the player chooses a number (colour) between 1 and 2 which the console 12 sends to the smartcard as a message to the server 11. The console 12 then requests the smartcard to generate a random number between 1 and 2. If the player selection matches the smartcard selection the player wins, otherwise the player loses. Both the console 12 and server 11 can determine the game outcome from the player choice and the smartcards randomly determined choice.

Alternatively the smartcard first generates the random number, the player selects a colour, and only then does the smartcard disclose the colour chosen.

Using the card index the server 11 verifies the player selected the card colour before the colour was disclosed by the smartcard.

Odds Gamble Game Description

An odds gamble is similar to double up, except the player chooses the odds to play. The odds chosen are both the random number range and the amount by which the stake will be multiplied if the player wins.

Preferably the player chooses the odds, N to 1 (eg. 2:1 or 3:1), and the smartcard generates a random number in the range 1 to N. If the random number is the winning value (eg 1) the player wins, otherwise the player loses.

Alternately the player chooses the odds, N to 1, then makes a selection. The game is described to the smartcard as a player selection of a number (from 1 to N) followed by a smartcard generated random number in the range 1 to N. If player and smartcard selections match the player wins.

Slots Game Description

A typical spinning reel slot game has 3 reels, each of 30 symbols with 3 symbols from each reel visible to the player on the screen. This particular game requires the generation of 3 independent random numbers in the range 1 to 30, representing the final stopping positions of each of the 3 reels. A choice made by the player is not applicable in this situation.

The console 12 requests an array of 3 independently selected random numbers from the smartcard, each random number being in the range 1 to 30. The smartcard then returns the result to the console 12 and server 11, as to which of the N possibilities was randomly selected for each selection in the array of M, as described previously. In the case that reel strips have different numbers of stop positions a random number is generated in the appropriate range for each.

Blackjack Game Description

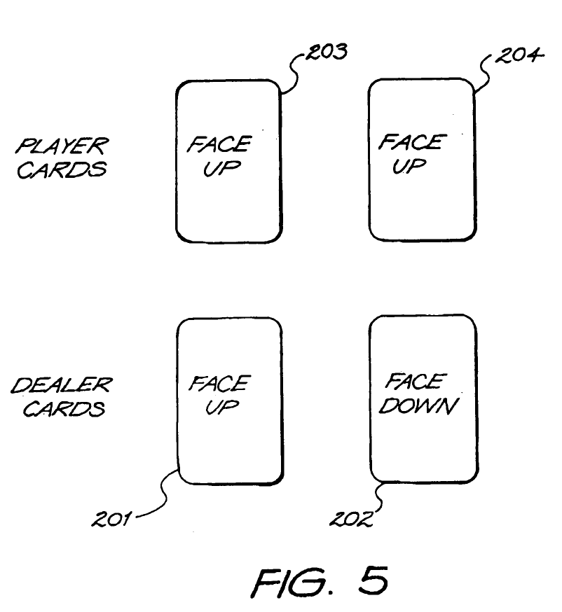

The game of blackjack is more complex and requires a game specific command. In one implementation of blackjack four cards 201, 202, 203, 204 are selected from a deck, two for the dealer 201, 202 and two for the player 203,204 (See FIG. 5). One of the dealer's cards 201 and both player cards are displayed to the player. The other dealer card 202 is hidden. If the displayed dealer card is an ace the player may choose to take an insurance bet against a dealer blackjack (i.e. that the hidden card has a count of ten). If the dealer has a blackjack the game ends and the player is paid a win only if they took an insurance bet. If the dealer did not have a blackjack the game continues. Using the usual rules of blackjack the player and dealer choose additional cards from the deck.

First, a shuffled deck of cards is created by generating an array of up to fifty two unique random numbers, each in the range one to fifty two. Next the console 12 reads three of the cards from the array and displays to the player the two player cards 203, 204 and one dealer card 201, leaving the second dealer card 202 displayed facedown. If the displayed dealer card is an ace then using a blackjack specific command the console 12 checks if the second dealer card 202 has a count of ten. The smartcard does not disclose the actual value of the card 202, only if it had a count of ten, or not. Additional player cards are selected as required from the remaining numbers in the array.

Keno Game Description

To play Keno the player selects X unique numbers in the range 1 to Z and the console 12 selects Y unique numbers in the range 1 to Z. Typically X=10, Y=20, and Z=80. The console 12 compares the X player selected numbers with the Y console selected numbers and pays the player according to the number that match.

First the player makes a selection of X numbers, which are sent as a message for the server 11 to the smartcard. This proves the player selection before the smartcard generates the console selection The console 12 then requests the smartcard to generate an array of Y unique numbers in the range 1 to Z and reads the generated numbers. The console 12 reads these numbers and scores the game according to the quantity that match.

Accounting Description

In the preferred implementation the server performs accounting. Alternately the smartcard may also be used to perform accounting to allow independent auditing of player gambling and hence provide enhanced security against tampering at the server and help in resolving player disputes. Although the console can keep accounts these are not secure and are therefore of limited value. In this implementation an extra function description is used for the player bet, so that the smartcard can keep appropriate accounting of bets, wins and losses. These accounts may be read independently (of the server) from the smartcard but cannot be modified, except by the playing of games.

Download of Code to the Smartcard

To increase flexibility of the smartcard, code may be downloaded to it from the console 12. Security of the smartcard may be maintained in two ways:

The code that can be executed is restricted such that no possible code that is downloaded can compromise security. A simple interpreted language could easily satisfy this condition.

Downloaded code is encrypted such that only an authorised source could have generated it. Alternately a digital signature is used to show that the code is from an approved source.

A copy of the code or a one way hash function of it, is sent from the smartcard to the server 11 as a means of verification, with the server confirming the code before it is executed.

Off-Line Gaming

The smartcard may be used in off-line gaming, in which the games may be played without continuous communication with a server 11.

The smartcard is used to generate and record game outcomes of games played without communication to the server 11. When communication is re-established with the server 11 the recorded games are sent to the server for verification and account update.

A personal gaming machine comprising of a small hand held console, similar in concept to a “Gameboy™” games console or Radica:™ gaming toy, into which the smartcard is either inserted by the player or embedded by the manufacturer.

A traditional gaming machine with enhanced security features provided by an embedded smartcard.

Gaming on a home or business computer, with the computer as the console 12. Credits may be transferred to the card via a communications link to the casino. The computer may be an Internet terminal and credits transferred via Internet.

A plug in module for a game console 12 (eg. Sony Playstation or Nintendo Ultra64), containing the game program (game data) for the console 12 and the smart card. The module may additionally have a modem for communications.

In an off-line gaming application the number of games played is limited by the non-volatile storage available on the card and therefore data compression techniques may be used to increase the data storage capacity of the card.

Alternately the card may perform verification of the combinations for games itself instead of sending the game descriptions to the server 11. Therefore, the game descriptions are not stored within the card (except for the most recent, as required for game recall), saving space and increasing the number of games that may be played independently of the server 11. The server 11 need only check the total of wins and losses for these games. However, only games with combinations known to the smartcard can be compressed in this way. Any other game combinations played take the usual amount of non-volatile storage. In this implementation both the smartcard and console 12 may store game descriptions intended for later communication to the server 11, but they are not essential for security.

Server Verification of Games

The server 11 verifies the games played on the console 12 using the game description message from the smartcard. At least the following checks are made:

If implemented, the server 11 checks that the random number seed index is valid.

The game descriptions are consistent with the game type selected.

The gamble is correct for the game type played.

The amount bet is valid, including maximum bet, maximum win, etc.

The game has been fully described and that no messages from the smartcard are missing.

The server 11 may know the initial random number and hence be able to calculate all future random numbers. It can therefore check the random numbers generated by the smartcard.

For example, a game may allow up to five red/black double ups following a win on a spinning reel game. The server 11 would check that the double up followed a win, that no more than five double ups were played, that each successive double up was played only as a result of a win on the previous game, and that the odds described to the smartcard for each game were correct. The gamble is not complete until the last double up has been played, and preferably the end of game message has been sent. The server 11 cannot update the account until each of the outcomes is known, in the correct sequence. The game type is therefore different for each of the games played (i.e. there are a maximum of six game types played), or another field is added to the game description message to describe which game in the sequence is being played.

Additionally games may be validated by another server 11 whose sole purpose is to verify games. All communications between smartcard and server 11 are copied to the verification server by the game server. The verification server 11 must know the encryption keys used for communication between game server and smartcards 23. A jurisdictional body may, for example, use a verification server 11 to verify the correct operation of the casinos operating within its authority.

Optionally, the encrypted game outcome messages from the smartcard to server include the random numbers used to determine the game outcome. The server verifies that the random numbers produce the specified game outcomes and that the random numbers are valid (either by checking the sequence or statistical tests).

Game Recovery

In the event of an interruption to the game sequence (power down, communications failure, console failure etc.) it is possible to recover to the same position in the sequence via several means, including;

The console 12 may have non-volatile storage from which it can recover its previous state of play.

Outstanding game outcomes in the smartcard are first transmitted to the server 11. Once all game outcomes have been acknowledged, the server 11 has a complete record of the state of game play and the console 12 may then request the current state.

In an alternate implementation the smartcard stores information sufficient to restore a game in its non-volatile memory, which is passed on request from the smartcard to console 12.

Communications

Prior to encryption messages may include a message type identification code and a message integrity code (eg. CRC or checksum or secure hash). An additional integrity code added after encryption ensures successful transmission of data over the communications link between the server 11 and console 12. Therefore, when either the smart card or server 11 detects errors within the encrypted message either may assume that these are not communication errors and that tampering is taking place and hence take appropriate action.

The console 12 may require secure communications with the server 11 separate to that required by the smartcard. This may include the need to download game graphics, sound and code, or player account information. Two methods may be used to accomplish this:

The servers 11 and console 12 communicate using the smartcard as the encryption means. The console 12 effectively encrypts and decrypts data using the smartcard as the encryption engine.

The console 12 requests an encryption key from the server 11 for the game session. The key is generated by the server 11, encrypted, and sent to the smartcard. The smartcard decrypts the key and gives it to the console 12 which then uses it for private communications with the server 11.

In a variation on the preferred implementation the console 12 or smartcard suspends games when communication delays with the server 11 exceed a preset time limit, thus ensuring that when the server or network is not operating the console does not play games.

Server to Smart Card Messages

The server 11 and hence the console 12, may send the following messages to the smartcard, as described elsewhere in this document:

Send random number seed to the smartcard.

Request previous game outcomes from the smartcard.

Request last game outcome from the smartcard.

Request Card ID (or public key) from the smartcard.

Send game outcome receipt acknowledge to the smartcard.

Security poll requiring an immediate and unforgeable response.

Messages from the server 11 are encrypted to prevent eavesdropping or tampering, especially where game outcomes and random numbers are being sent. The server 11 unforgeably identifies itself to the smartcard in its communications by:

Encrypting messages using the smartcards encryption key, if that key is secret and shared only between the server 11 and smartcard.

By the server 11 having at least one other encryption key that is a secret known only to the server and smartcard(s).

By the server 11 having a public key pair and encrypting or signing messages with its private key. The smartcard(s) verify messages with the public key.

To ensure cryptographic freshness and prevent attacts by replaying messages to the smartcard, the message may contain two additional fields (similar to those in smartcard to server messages) in which:

A randomising code ensures that otherwise identical messages produce different messages when encrypted.

An index field is used to determine if the message is fresh. Typically this field contains an incrementing 32-bit number and for a message to be valid it must contain a larger index number than the last valid message.

A replay attact might, for example, replay the transmission of a random number seed and cause it to be reused. The optimum game choices could then easily be determined.

Smart Card to Server Messages

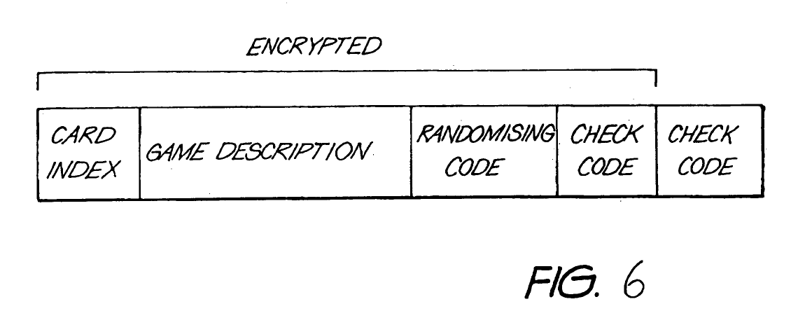

Each command sent to the smartcard used to describe games or generate game outcomes for the console 12 also generates an encrypted and unforgeable message to the server 11 (See FIG. 6). Each type of game description or command will cause a different type of message to the server 11 to be generated. Each message is comprised of the card index, game description and optional integrity code (eg. checksum or CRC), which is then encrypted. Therefore four basic messages types are used (message from console 12 to server 11, random number array generation and selection, and the blackjack specific command) with more being added as required.

The card index is used to uniquely identify and sequence each game description sent from console 12 to the smart card, and hence to the server 11. It is automatically incremented for each description and used by the server 11 to determine the order and completeness of all games. Typically the card index is a 32-bit number. For example, if the server 11 receives messages with card indexes of one and three only, it knows that it is missing message two. If a message is lost and needs to be resent to the server 11 the original card index is used and the message is identical, except in an implementation where a randomising number is included in the message. It also knows that game description two was made after description one, and that three was after two. The card index also prevents tampering by replay attacts in which messages are recorded and resent to the server.

To improve security a randomising code may be included in the encrypted message to ensure that every message from the smartcard is unique, even if it contains otherwise identical data. The randomising code is different for each transmission and would typically be a simple count value or random number. The server 11 ignores the randomising code.

In the alternate implementation where random number seeds are generated by the server 11 the encrypted game outcome message sent from the smartcard to the server also includes the index number that was received with the random number seed used for that game. Including the index ensures that all packets of encrypted data sent back to the server 11 are unique, and that a previous winning game outcome message cannot be resent to the server. The server 11 checks the index number to ensure that this game outcome has not been previously recorded. Old messages or messages for games that have never occurred are evidence of attempted tampering. The random numbers may also be included in this return packet as further confirmation.

Messages to and from the smartcard may be combined reduce the amount of data transmitted and the response time. The response time of the card to game commands is composed of communications times, command processing time, and E²PROM write time. Therefore to reduce the response time commands to, and results from, the smartcard may be combined. For example, if the E²PROM write time is 5 ms, three commands each resulting in writes to E²PROM would require at least 15 ms. However if the commands are combined only a single 5 ms E²PROM write is required, saving 10 ms.

Attacks on smartcard security may be attempted by timing analysis of smartcard responses to commands from the console 12. Two methods may be used to prevent this:

A small random time delay may be introduced into all communication from the smartcard to the console 12.

All responses from the smartcard are delayed to the maximum time that any response could take. All messages therefore take the same amount of time from initiation.

Random Number Generation

The random numbers used to determine game outcomes are generated either within the smartcard, by the server 11 and sent to the smartcard, or a combination of both.

Smartcard Generated Random Numbers

In the preferred implementation the smartcard generates the random numbers required for outcomes from an initial seed. The seed may be set once during configuration/manufacture or updated at various times by the server 11. An implementation that does not allow the server 11 to update the seed eliminates the possibility that a compromised server can be used to influence or determine the game outcome and hence cheat the system. In an implementation in which the random number seed can be updated the principals set forth for server generated random numbers are also applicable.

An obvious point of attack is the random number generator as it is on the smartcard. An automated attack can play a large number of games and record the outcomes to try to determine the random number sequence. One or more of the following methods can be used to prevent this attack:

The random number generator is reseeded from the server 11 periodically. Each time the generator is reseeded the attack analysis would have to restart.

When the set limit on the generator is reached without a new seed the smartcard refuses to accept new gambles.

The delay between generating random numbers can be sufficiently large that it takes too long to determine the sequence by exhaustive trial.

The generator used is unpredictable, even if its output can be recorded.

The results output from the smartcard do not indicate the exact random number generated, only a region in which it falls. Thus the random number is quantised, becoming much harder to determine.

An automated attack would preferably be made without gambling and thereby losing money. Therefore zero value gambles are either not allowed or enable a different type of random number generator. If this generator is compromised it is of no help in real games.

The smartcard generates an internal random number from an initial seed set during manufacture and combines (eg. exclusive or) it with a random number generated with a seed sent from the server 11. The random number sequence therefore changes when a new server seed is sent, but a compromised server cannot influence the outcome of games.

Server Generated Random Numbers

In this alternate implementation the server 11 generates random numbers and transmits them to the smartcard prior to the game requiring them. The server may generate all the random numbers required for games, but preferably a single random number seed is used to generate all the random numbers required for a game, reducing the amount of data transferred. For example, a five-reel slot game requires at least five random numbers, but five random numbers are easily generated from a single random number seed.

In a variation encrypted random seeds must be used within a set time period. Seeds having a limited lifetime, of say 1 hour, shorten the time seeds are available for malicious decrypting. Both encrypted and non-encrypted ‘use by dates’ are attached to each encrypted seed to enable the console 12 and smartcard to discard seeds that are no longer valid. If a game is played with an invalid seed the server 11 will declare that game void. To prevent tampering whereby messages about losing games are delayed and voided by the server only wins are voided, not losses.

In another variation random numbers are continually sent to the smartcard. The smartcard discards all those that it does not use, and optionally informs the server 11 that it has done so.

When the console 12 is initialised for game play it requires random number seeds for the smartcard. These may be stored locally from the previous game session or will be generated on request, by the server 11. The console 12 stores multiple seeds in a buffer (FIG. 7), the quantity being determined by the delay associated in requesting more over the network.

The console 12 or an intermediate level server in an hierarchical system may store seeds and these can be used in a new session. The console 12 is therefore able to immediately supply random number seeds to the smartcard as required and when the console buffer runs low it will request more from the server 11.

Where the random number seeds are sent with a unique index the server 11 may need to determine the last seed used by the smartcard, to enable the next numbers in the sequence to be generated. In this implementation the server 11 is able to query the smartcard during initialisation for the sequence number (or entire game outcome message) of the last game played.

In an alternative implementation, random number seeds are sent from the server 11 with an embedded index number, which is returned to the server with the game outcome that was created with that random number. The index number prevents cheating where a random number seed is reused and further enables the server 11 to verify game outcomes. When each new random number seed is received the embedded index is checked against that of the most recent game outcome stored in E²PROM. There are three possible outcomes:

The received index is newer (i.e. larger) than that of the last stored game, indicating that it is a new seed, for a new game.

The received index is the same as the stored index, indicating that the game has already taken place, and the console 12 is so informed. No new gamble choice will be accepted.

The received index is older (i.e. less) than that of the last stored game. This is either the result of an error in the system or an attempt at cheating. This condition is signalled back to the console 12 and the random number seed discarded.

Optionally the index must be the next in the sequence for the smartcard to accept the communication. For example, if the last index was 1000, the next must be 1001. In an alternate implementation is for the next random number seed to be sent in response to the encrypted game outcome for the last game being received by the server 11. However, a delay may occur before the next game if sufficient seeds are not available during subsequent games.

Random Number Server

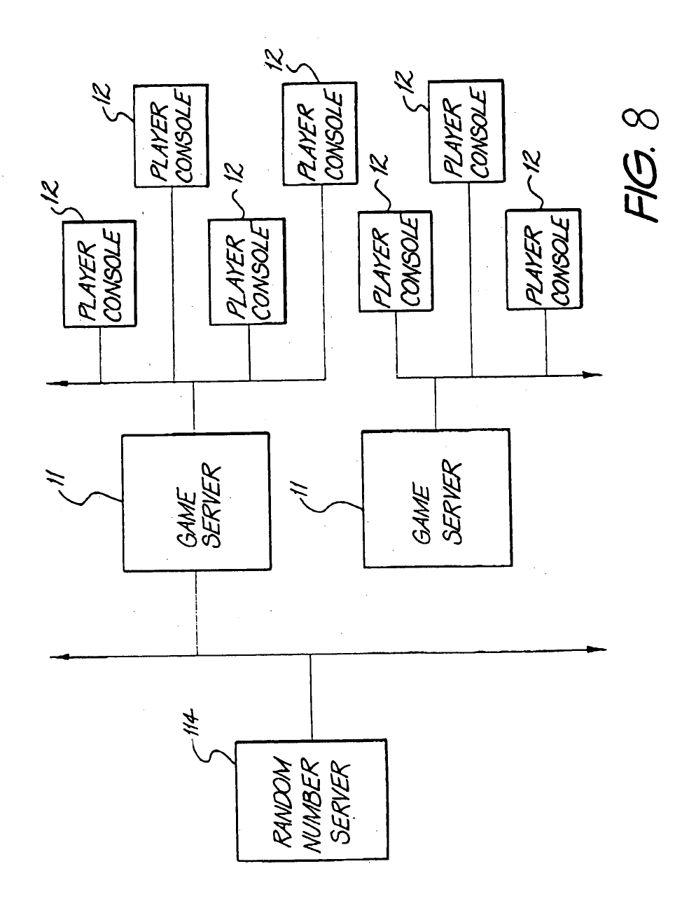

In a variation on server generated random numbers and to increase security or control over gaming (by government jurisdiction), a random number server 114 (FIG. 8) may be used to create random number seeds. The random number server 114 generates and encrypts seeds using an encryption key not known to the game server(s) 11 and sends them to the game server(s) 11 for distribution to the player consoles 12 and hence smartcards 23. It is therefore not possible for a compromised server to be used to influence or determine the outcome of games.

Random seeds may be encoded such that they can only be used by a specific smartcard, to reduce the possibility of cheating by sending the same seed to multiple smartcards.

The smartcard may generate an acknowledgment message to confirm that it has received the random number seed, which the game (or verification) servers then use to verify the correct operation if the system. When sending the acknowledgment message, the smartcards card index is incremented, allowing the game (or verification) server to detect when the same random number has been used by multiple smartcards, as acknowledgments cannot be deleted without detection.

Multiple sources of random numbers may be combined within the smartcard to produce the random number to be used to generate the game outcome. The multiple sources may be used for each random number required or periodically used to randomise the sequence further, for example, the server 11 sends the smartcard its own random number together with that from two independent random number servers 114. The smartcard in addition has its own random number generator seeded during manufacture of the card. The four random numbers are combined (eg. exclusive or) to form the random number(s) used to generate a game outcome. So long as at least one of the sources of a random number is not compromised the game outcome cannot be influenced or predicted.

Security

Preferably security will be provided in signals transmitted between a game server and a smartcard by use of cryptographic techniques, with the following general principles being employed:

1. All critical transmissions will be encrypted using state-of-the-art encryption schemes;

2. Key management schemes will be used to ensure the security of IDs and keys;

3. The freshness of all transmissions will be ensured and monitored

4. Mutual authentication of principals will be routinely implemented.

5. Cryptographically strong, unbiased pseudo-random number generators will be used through-out the implementation.

In applications where the smartcard is associated with a single player or account (such as Internet gaming) it is an ideal means of identifying the player to the console 12. Preferably to prevent unauthorised use of the smartcard players are required to identify themselves to the smartcard in order for it to function, typically using a pin number, password or biometric identification. Multiple accounts (eg. members of a family) may be accessed using a single smartcard and multiple pins, passwords or biometric identification.

Although smartcards are very hard to compromise, they cannot be assumed to be perfectly secure. The potential for breaking the security on the smartcard is acknowledged and the system designed to minimise the damage caused. One or more of the following methods may be used to improve security or detect or limit damage:

A measure of physical security may be provided when the smartcard is not player accessible. This is only applicable in situations where the player is not required to access the smartcard.

A different encryption key is used on each smartcard, so that if one smartcard is compromised not all cards are compromised.

The smartcard issuer (eg. Casino) may retain the ownership rights to cards and can reclaim a smartcard at any time. This allows them to check for physical compromise and remove any cards from use that seem to be suspicious.

The server 11 can cancel a smartcard. The server 11 will not allow any transactions with that smartcard and may notify its human attendants of any such attempts.

To prevent stolen cards being used the card ID is programmed when the cards are manufactured. Cards cannot be used without the server 11 knowing the card ID and hence stolen cards cannot (safely) be used.

When the smartcard detects attempted tampering via erroneous requests it may respond with a randomly generated response message that appears the same as a correct response, but is meaningless.

When the smartcard detects attempted tampering via erroneous requests it may delay its response to the next request by a significant time. Automated tampering will be slowed down to the point of worthlessness, but normal activity will never encounter delays.

The server 11 examines the pattern wins and losses associated with individual cards for evidence of tampering. For example, if the return to the player exceeds the statistically likely amount or a statistically significant distribution exists in the size of bets between wins and losses (i.e. large bets on wins and small bets on losses).

A smartcard that is used from a second location at a distance from the first location that is impossible to reach in the time between uses. This may indicate duplicate smartcards 23.

In some applications where the smartcard is continuously on-line, such as hotel in-room gaming, security may be enhanced by the server 11 periodically establishing secure communications with the smartcard. Only the smartcard is able to correctly respond, hence there is some assurance that the smartcard is not being tampered with. In addition the smartcard may require a similar response from the server 11, to check for itself that tampering is not taking place, and take appropriate action (eg shut down) if it is.

Verifiability of the smartcard may be enhanced by a command causing the smartcard to dump its entire memory contents. Security demands that this command can only be issued by an authorised source, typically a server 11 (in which case the memory dump may be encrypted) or test equipment. Preferably the command is encrypted using the server 11 encryption key or a key reserved especially for this purpose.

Encryption

The purpose of encryption between server 11 and smartcard 23 is to both hide the data (especially random numbers) and authenticate the source of the message.

Either symmetric or asymmetric (public key) encryption may be used for smartcard to server communications. When public key encryption is used the public key need not be made public (except in an hierarchical system or to identify the smartcard to the server 11).

Preferably each smartcard has its own unique key, so that in the event of a single key (or smartcard) being compromised the entire system is not compromised. The server 11 uses a different key for communicating with each smartcard.

Alternatively, cards use the same key for communication with the server 11, which simplifies key management, but leads to potential security problems

In the hierarchical or verification server system public key or a hybrid encryption scheme may be preferred as it enables a feature where each of the servers is able to decode messages from the smartcard without possibility of any server 11 compromising the system by forging messages.

To further prevent tampering messages may be padded out with extra data, prior to encryption, that is randomly generated each time a message is sent. The messages may also be padded out to the same length each time. Each time an encrypted message must be resent (eg. due to a system error) it will be different. It will not therefore be possible to determine which messages are associated with which events. The recipient may ignore the extra data.

Server

The server 11 functions much as a server for a traditional distributed gaming system would, with some additional features:

An account is maintained for each smartcard that exists. In addition to player accounting and games information the account holds the encryption key(s) used for the smartcard and other information required to monitor security.

Software to detect tampering.

Encryption for smartcard communications and highly secure storage of smartcard keys.

The server 11 reads the game type played and verifies the gamble. The outcome and amount bet are used to adjust the players account. Any discrepancy between the server determined result and that of the game console are either system bugs or an attempt at tampering.

Security Server

Ensuring security of the server 11 may be a difficult and expensive process. In theory any software modifications on the server 11 require complete recertification of the software.

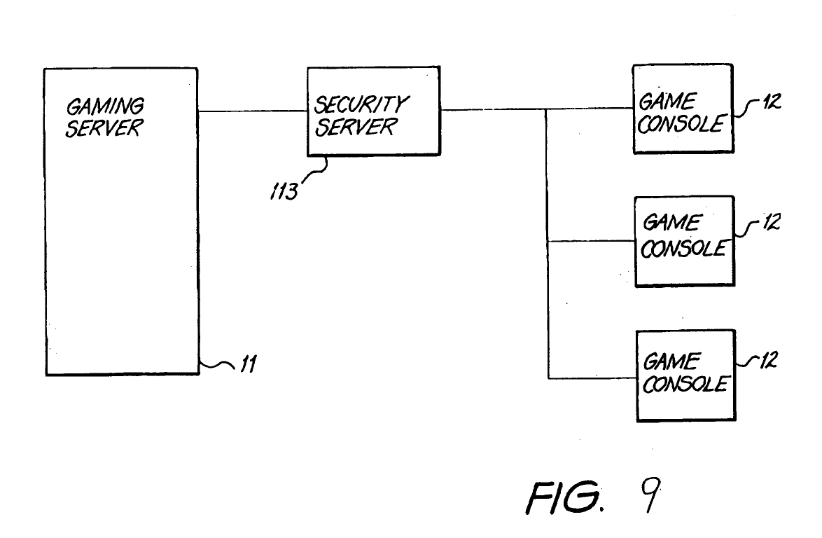

An encryption server 113 (See FIG. 9) may be provided to physically separate the functions of the server 11 and encryption. When software unrelated to security is changed on the server 11 the security system does not need to be recertified. All communications between the server 11 and consoles 12 passes through the security server 113.

To match the bandwidth of the game server 11 and security server 113 to the application one or more game servers 11 may be used with one or more security servers 113, in any combination.

Hierarchical Server Architecture

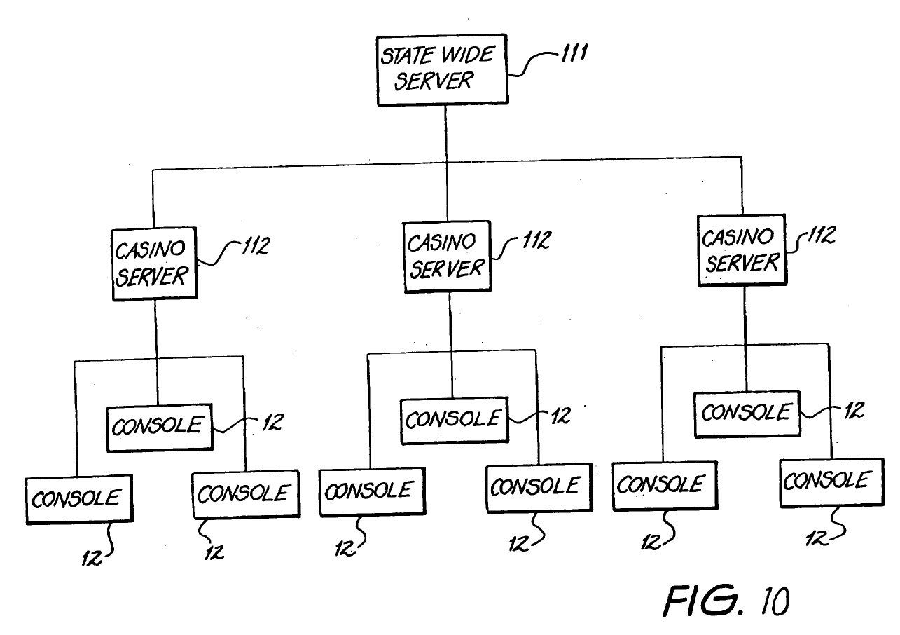

A large network may be constructed containing an hierarchy of servers (See FIG. 10). The function of the servers is somewhat different to that described for a single server system. Advantages over a single level network are possible:

When random numbers are generated by the top level server 111 the games cannot operate without it, ensuring a high level of control. The top level server 111 is able to maintain highly accurate accounting of the entire system.

The lower level servers 112 need not have a high level of security if they are not involved in payouts, in which case payouts are determined by a higher level server 111 that does have high level security.

The low level servers 112 are used for local monitoring and accounting and can improve response time.

In a very large system the load is distributed across multiple servers. Lower level servers 112 off load communications traffic.

Communications from the console 12 to its server 11 must be relatively fast to keep games responsive. Communications between the levels of server need not be fast, if the top level server 111 generates a large number of random numbers and downloads them to the lower level servers 112 for later use. Games can proceed without immediate communication to the top level server 111 until the supply of random numbers runs out.

Smartcards 23 may use public key encryption (or digital signatures) on game outcome messages, with the public key known to each of the appropriate levels of servers. In this implementation both the low level server 112 and higher level server 111 can keep track of games and accounting information. The low level server 112 can verify transactions, but not modify them.

Examples of possible implementations are:-

State wide networks spanning an entire state, such as Nevada in the USA or Victoria in Australia. The lower level servers 112 would be located in casinos or clubs and the top level server 111 controlled by the governing body of that state.

On Internet a central high security server 113 distributes games (including random numbers) to lower security servers. The lower level servers 112 have a reduced responsibility to not loose games or results, but since it is not possible for them to tamper with games, security requirements are reduced. Attempts to tamper are easily detected by the top level server 111.

A low level server 112 is implemented on an aeroplane. Communications between the aeroplane server 112 and ground based high level, high security server 113 may be slow, or only used when the plane has landed.

Verification Server

In an alternate implementation verification of games and accounts also takes place on a verification server, in addition to verification by the normal game server. This enables enhanced security as some types of tampering at the game server can be detected, depending on the system implementation used. The verification server may be run, for example, by a government controlled regulator to audit commercial establishments.

Copies of all communications to the smartcard affecting game outcomes, from the smartcard to server reporting game outcomes, and acknowledgments, are sent by the game server to the verification server.

Messages are encrypted, such that the verification server can read messages between the game server and smartcard. This may require that the verification server has the encryption keys shared by the game server and smartcard, or that an encryption method is used that allows a three way secure communication. Preferably, the game and verification server cannot forge the identity of the other.

Verification Mode

The secure storage means may be provided with a verification mode in which the memory contents of the secure storage means may downloaded to an external device. Preferably, in the interests of security, secret encryption keys stored within the secure storage means are not disclosed. Crytographic techniques are used to ensure only an authorised party is able to initiate the verification mode. Typically it is the server using its secret key which is authorised, but other parties may be used when the secure storage means is provided with a secret verification key. Preferably invocation of device verification disables the secure storage means from further use, except for device verification, and minimal changes are made to memory contents.

Downloaded Console Code

Traditional gaming machines do not allow the downloading of code because tampered code can cheat the system. Because console security is solely dependent on the smartcard and encrypted communications, then it is perfectly reasonable to download code to the console 12 as part of the game package. No possible code can compromise the security of the system, except in so far as it may mislead the player into the nature of the game being played. However, to further enhance security, code may be authenticated with methods such as digital signatures or encryption.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

I claim:

1. A method of operating a gaming system including one or more secure storage and processing devices, a gaming server and one or more gaming consoles, each console including a secure storage and processing device read/write interface and a user interface allowing a user to initiate a game and observe a result, and the server including a random seed generator and being in communication with a secure storage and processing device read/write interface, the method comprising:
the server creating a plurality of random seeds, and communicating the seeds for storage in one of the secure storage and processing devices, via the secure storage and processing device read/write interface with which the server is in communication, to provide a plurality of predetermined outcomes for future games to be played on one or more of the Gaming Consoles; and
communicating between of one of the gaming consoles and one of the secure storage and processing devices via the respective secure storage and processing device read/write interface, and upon receipt of a user input initiating a game on the console, wherein the game requires a set of random numbers to produce an outcome, producing in the secure storage and processing device, a set of random numbers required to play a game, from one of the seeds and producing a game play sequence including a game and/or gamble outcome indication determined by the random numbers produced by the secure storage and processing device alone or in combination with a user input.

2. The method of claim 1, wherein when calculating the set of random numbers from each random seed, the secure storage and processing device uses an algorithm known to the server whereby the server can predict the outcome derived.

3. The method of claim 1, wherein the secure storage and processing device is a smartcard or smartcard chip.

4. The method of claim 1, wherein after the set of random numbers to be used to determine a gamble outcome are produced by the secure storage and processing device, the console then chooses a game outcome which will achieve that gamble outcome.

5. The method of claim 1, wherein after the set of random numbers to be used to determine a gamble outcome are produced by the secure storage and processing device, the secure storage and processing device then chooses a game outcome which will achieve that gamble outcome and communicates the chosen game outcome to the console.

6. The method of claim 1, wherein each secure storage and processing device generates game verification data which is stored until the secure storage and processing device is in communication with the gaming server at which time the secure storage and processing device communicates the game verification data to the gaming server.

7. The method of claim 6, wherein the gaming server is in communication with each gaming console, whereby when one of the secure storage and processing device is connected to a console the secure storage and processing device communicates the game verification data to the gaming server via the console.

8. The method of claim 6, wherein when one of the secure storage and processing devices is connected to a console the gaming server communicates new random seeds to the secure storage and processing device via the console thereby allowing the player to recharge the games stored on the secure storage and processing device.

9. The method of claim 1, wherein the secure storage and processing device, need not be in communication with the gaming server when the game is played, and each time the secure storage and processing device is next connected to the gaming server, it will generate and send a signal to the server indicating the stored game verification data corresponding to the random seeds that have been used.

10. The method of claim 1, wherein game play includes a step in which the player makes a bet on the outcome of each game.

11. The method of claim 10, wherein secure storage and processing device is programmed with a the maximum loss value and the secure storage and processing device will inhibit further play of the games represented by the unused random seeds stored on the secure storage and processing device when the sum of player bets exceeds the wins by the maximum loss value or greater.

12. The method of claim 11 wherein secure storage and processing device prevents the player placing a bet that will cause the maximum loss value to be exceeded.

13. The method of claim 3, wherein the secure storage and processing device read/write interface of each gaming console communicates with secure storage on the smartcard via a secure communications system provided by a further smartcard device.

14. The method of claim 1, wherein the console sends a signal to the secure storage and processing device describing a state of a game being played for communication to the gaming server.

15. A gaming system comprising:
at least one gaming console, the console including secure storage and processing device read/write interface and a user interface allowing a user to initiate a game and observe a result;
at least one secure storage and processing device;
a gaming server in communication with a secure storage and processing device read/write interface and which creates random seeds, and communicates the seeds to one of the secure storage and processing devices, via the secure storage and processing device read/write interface with which it is communicating, to provide a plurality of predetermined outcomes for future games to be played on one or more of the Gaming Consoles; and
wherein the secure storage and processing device calculates, from each of the random seeds it has stored, a set of random numbers indicating a game or gamble outcome to be used by one of the gaming consoles for a future game to be played on the gaming console, the user interface of the gaming console including game controls to receive a user input initiating a game in response to which the console initiates a game play sequence including a game and/or gamble outcome indication on the user interface determined by the game or gamble outcome information provided by in the secure storage and processing device alone or in combination with a user input.

16. The system of claim 15, wherein the secure storage and processing device includes a random number generator which uses an algorithm known to the server whereby the server can predict the set of random numbers derived from each random seed.

17. The system of claim 15, wherein the secure storage means is a smartcard or a smartcard chip.

18. The system of claim 15, wherein the console includes a selection means for choosing game outcomes and after the set of random numbers to be used to determine a gamble outcome are calculated by the secure storage and processing device, the console then chooses a game outcome which will achieve that gamble outcome.

19. The system of claim 15, wherein the secure storage and processing device includes a selection means for choosing game outcomes and after the set of random numbers to be used to determine a gamble outcome are calculated by the secure storage and processing device, the secure storage and processing device then chooses a game outcome which will achieve that gamble outcome and communicates the chosen game outcome to the console.

20. The system of claim 15, wherein each secure storage and processing device generates game verification data which is stored until the secure storage and processing device is in communication with the gaming server at which time the secure storage and processing device communicates the game verification data to the gaming server.

21. The system of claim 20, wherein the gaming server is in communication with each gaming console at least intermittently, whereby when one of the secure storage and processing devices is connected to a console the secure storage and processing device communicates the game verification data to the gaming server via the console.

22. The system of claim 20, wherein when one of the secure storage and processing device is connected to the gaming server via a console, the gaming server communicates new random seeds to the secure storage and processing device via the console thereby allowing the player to recharge the games stored on the secure storage and processing device.

23. The system of claim 20, wherein the secure storage means, need not be in communication with the gaming server when the game is played, and each time the secure storage means is next connected to the gaming server, it will generate and send a signal to the server indicating the stored game verification data corresponding to the random seeds that have been used.

24. The system of claim 15, wherein the console includes wager input means and the game play includes a step in which the player makes a bet on the outcome of each game.

25. The system of claim 24, wherein secure storage and processing device is programmed with a the maximum loss value and the secure storage and processing device will inhibit further play of the games represented by the unused random seeds stored on the secure storage and processing device when the sum of player bets exceeds the wins by the maximum loss value or greater.

26. The system of claim 25, wherein secure storage and processing device prevents the player placing a bet that will cause the maximum loss value to be exceeded.

27. The system of claim 17, wherein the secure storage and processing device read/write interface of each gaming console communicates with secure storage on the smartcard via a secure communications system provided by a further smartcard device.

28. The system of claim 23, wherein the server includes an auditing device for checking game verification data returned from the secure device in the console.

29. The system of claim 17, wherein a non-volatile memory is provided in the smartcard device for recording player bet values, and the total value owed to the player.

30. The system of claim 15, wherein the console sends a signal to the server via the secure storage means describing a state of a game being played to the gaming server.

31. A secure storage and processing device for use in a gaming console which includes a user interface allowing a user to initiate a game and observe a result, the secure storage and processing device being arranged to store random seeds and to calculate, from each of the random seeds it has stored, a set of random numbers indicating a game or gamble outcome to be used by the console for a future game to be played on the Gaming Console, the console further including game controls to receive a user input initiating a game and to produce a game play sequence including a game and/or gamble outcome indication determined by the game or gamble outcome information provided by the secure storage and processing device alone or in combination with a user input whereby the secure storage and processing device provides a game or gamble outcome to the console in response to the console signaling the commencement of a game.

32. The secure storage and processing device of claim 31, wherein the secure storage and processing device is arranged to communicate with a gaming server via a gaming console, the server being arranged to provide random seeds for storage in the secure storage and processing device from which the secure storage and processing device will calculate the random numbers indicating game or gamble outcomes in relation to future games.

33. The secure storage and processing device of claim 31, wherein the secure storage and processing device is a smartcard or a smartcard chip.

34. A secure removable control device for use in a gaming console which includes a user interface allowing a user to initiate a game and observe a result, the secure removable control device including a secure storage and processing device arranged to store random seeds and to calculate, from each of the random seeds it has stored, a set of random numbers indicating a game or gamble outcome to be used by the console for a future game to be played on the gaming console, wherein a user input received via the user interface initiates a game and causes the control device to produce a game play sequence including a game and/or gamble outcome indication determined by the game or gamble outcome information provided by the secure storage and processing device alone or in combination with a user input whereby the secure storage and processing device provides a game or gamble outcome to the console in response to the console signaling the commencement of a game.
